(19) United States
(12) Patent Application Publication
(10) Pub. No.: US 2026/0196509 A1
(43) Pub. Date: Jul. 9, 2026

(54) AQUEOUS CATHODE SLURRY WITH DISPERSANT

(71) Applicant: GM GLOBAL TECHNOLOGY OPERATIONS LLC, Detroit, MI (US)

(72) Inventors: Nathaniel Hardin, Farmington Hills, MI (US); Jung Hwi Cho, Madison Heights, MI (US); Sanaz Ketabi, Rochester Hills, MI (US); Hayden Cunningham, Detroit, MI (US)

(73) Assignee: GM GLOBAL TECHNOLOGY OPERATIONS LLC, Detroit, MI (US)

(21) Appl. No.: 19/015,237

(22) Filed: Jan. 9, 2025

(51) Int. Cl. H01M 4/62; B60L 50/60; H01M 4/02; H01M 4/131

(52) U.S. Cl. CPC H01M 4/622; B60L 50/60; H01M 4/131; H01M 2004/028; H01M 2220/20

(57) ABSTRACT

Batteries, vehicles with batteries, and methods for making batteries are provided. A method for making a battery includes forming an amphiphilic polymer dispersant; forming an aqueous cathode material slurry by concurrently or consecutively adding to water: the amphiphilic polymer dispersant, a positive electroactive material; and a binder; and forming a cathode from the aqueous cathode material slurry.

### INTRODUCTION

The technical field generally relates to rechargeable batteries and more particularly relates to methods for making cathodes that avoid use of undesirable substances.

High-energy density, electrochemical cells, such as lithium-ion batteries can be used in a variety of consumer products and vehicles, such as Hybrid Electric Vehicles (HEVs) and Electric Vehicles (EVs). Typical lithium-ion and lithium-sulfur batteries include a first electrode, a second electrode, an electrolyte material, and a separator. One electrode serves as a positive electrode or cathode (on discharge) and another serves as a negative electrode or anode (on discharge). A stack of battery cells may be electrically connected to increase overall output. Typical rechargeable lithium-ion batteries operate by reversibly passing lithium-ions back and forth between the negative electrode and the positive electrode. A separator and an electrolyte are disposed between the negative and positive electrodes. The electrolyte is suitable for conducting lithium-ions and may be in solid (e.g., solid-state diffusion) or liquid form. Lithium-ions move from a cathode (positive electrode) to an anode (negative electrode) during charging of the battery, and in the opposite direction when discharging the battery.

Positive electrodes or cathodes having a high loading density of positive electroactive materials are desirable to increase overall cell energy density. For example, greater loading of electroactive materials increases a relative amount of positive electroactive materials relative to inert materials present in the electrochemical cell, such as current collectors and separators. Practically, however, loading of positive electrode electroactive material layers have been limited due to difficulties in processing and applying slurries. For example, electrochemical performance may be compromised by inferior liquid phase lithium ion transfer kinetics and the lack of structural integrity of thick electrodes, which deteriorate the life and power/fast charging performance.

Thus, it would be desirable to form electrochemical cells or batteries incorporating positive electrodes/cathodes that provide higher energy density to increase storage capacity and/or reduce the size of the battery, while maintaining a similar cycle life as other lithium ion batteries. It would further be desirable to provide methods for making such positive electrodes/cathodes that avoid use of undesirable substances. Furthermore, other desirable features and characteristics of the present disclosure will become apparent from the subsequent detailed description and the appended claims, taken in conjunction with the accompanying drawings and the foregoing introduction.

### SUMMARY

In one embodiment, a method for making a battery is provided and includes forming an amphiphilic polymer dispersant; forming an aqueous cathode material slurry by concurrently or consecutively adding to water: the amphiphilic polymer dispersant, a positive electroactive material; and a binder; and forming a cathode from the aqueous cathode material slurry.

In certain embodiments of the method, forming the amphiphilic polymer dispersant includes performing a post-secondary modification of Maleic-anhydride-containing polymers using alkyls having a nucleophilic functional group.

In certain embodiments of the method, forming the amphiphilic polymer dispersant includes forming the polymer dispersant with an alkyl-attached functional group and an ionic-based functional group.

In certain embodiments of the method, the positive electroactive material includes sulfur/carbon composite material, lithium iron phosphate (LFP), lithium ion manganese oxide (LMO), lithium manganese (LMN), nickel cobalt manganese aluminum (NCMA), and/or a combination thereof.

In certain embodiments of the method, the binder includes polyacrylic acid (PAA), polyvinyl pyrrolidone (PVP), polyvinyl alcohol (PVA). carboxymethyl cellulose (CMC) and styrene-butadiene rubber (SBR), carbohydrates, latex, and/or a combination thereof.

In certain embodiments of the method, the aqueous cathode material slurry has a solids content of less than 5 wt % of the amphiphilic polymer dispersant and at least 95 wt % of the positive electroactive material; based on a total weight of solids of the aqueous cathode material slurry.

In certain embodiments of the method, the positive electroactive material includes sulfur/carbon composite material and the binder includes lithiated polyacrylic acid (LiPAA).

In certain embodiments of the method, the positive electroactive material includes lithium iron phosphate (LFP) material and the binder includes carboxymethyl cellulose (CMC) and styrene-butadiene rubber (SBR).

In certain embodiments of the method, the aqueous cathode material slurry is free of N-methyl-2-pyrrolidone (NMP).

In certain embodiments of the method, forming the amphiphilic polymer dispersant includes performing a post-secondary modification of Maleic-anhydride-containing polymers using alkyls with a nucleophilic functional group; the positive electroactive material includes the positive electroactive material includes sulfur/carbon composite material, lithium iron phosphate (LFP), lithium ion manganese oxide (LMO), lithium manganese (LMN), nickel cobalt manganese aluminum (NCMA), and/or combinations thereof; the binder includes polyacrylic acid (PAA), polyvinyl pyrrolidone (PVP), polyvinyl alcohol (PVA). carboxymethyl cellulose (CMC) and styrene-butadiene rubber (SBR), carbohydrates, latex, and/or a combination thereof; the aqueous cathode material slurry has a solids content of less than 5 wt % of the amphiphilic polymer dispersant and at least 95 wt % of the positive electroactive material, based on a total solids weight of the aqueous cathode material slurry; and the aqueous cathode material slurry is free of N-methyl-2-pyrrolidone (NMP).

In another embodiment, a battery includes an anode current collector; an anode active material directly contacting the anode current collector; a cathode current collector; a cathode layer contacting the cathode current collector, wherein the cathode layer includes a uniform mixture of an amphiphilic polymer dispersant, a positive electroactive material, and a binder; a separator between the anode active material and the cathode layer; and an electrolyte in contact with the anode active material and the cathode layer.

In certain embodiments of the battery, the amphiphilic polymer dispersant is formed by post-secondary modification of a Maleic-anhydride-containing polymer using an alkyl with a nucleophilic functional group.

In certain embodiments of the battery, the amphiphilic polymer dispersant has an alkyl-attached functional group and an ionic-based functional group.

In certain embodiments of the battery, the positive electroactive material includes sulfur/carbon composite material, lithium iron phosphate (LFP), lithium ion manganese oxide (LMO), lithium manganese (LMN), nickel cobalt manganese aluminum (NCMA), and/or a combination thereof.

In certain embodiments of the battery, the binder includes polyacrylic acid (PAA), polyvinyl pyrrolidone (PVP), polyvinyl alcohol (PVA). carboxymethyl cellulose (CMC) and styrene-butadiene rubber (SBR), carbohydrates, latex, and/or a combination thereof.

In certain embodiments of the battery, the cathode layer includes a uniform mixture of the amphiphilic polymer dispersant, the positive electroactive material, the binder, and an additional electrically conductive material.

In another embodiment, a vehicle includes an electric traction motor configured to provide motive torque; and a battery system operatively connected to the electric motor and operable to provide electrical power to the electric motor, wherein the battery system includes a high voltage rechargeable battery including cell stacks, wherein each cell stack includes battery cells, wherein each battery cell includes a cathode electrode formed from an aqueous slurry of an amphiphilic polymer dispersant, a positive electroactive material, and a binder selected from polyacrylic acid (PAA), polyvinyl pyrrolidone (PVP), polyvinyl alcohol (PVA). carboxymethyl cellulose (CMC) and styrene-butadiene rubber (SBR), carbohydrates, latex, and/or a combination thereof; an anode electrode; a separator located between the anode electrode and the cathode electrode, and an electrolyte in contact with the anode electrode and the cathode electrode.

In certain embodiments of the vehicle, the amphiphilic polymer dispersant is formed by post-secondary modification of a Maleic-anhydride-containing polymer using an alkyl with a nucleophilic functional group.

In certain embodiments of the vehicle, the amphiphilic polymer dispersant has an alkyl-attached functional group and an ionic-based functional group.

In certain embodiments of the vehicle, the positive electroactive material includes sulfur/carbon composite material, lithium iron phosphate (LFP), lithium ion manganese oxide (LMO), lithium manganese (LMN), nickel cobalt manganese aluminum (NCMA), and/or a combination thereof.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes an RESS and a control system for control thereof, among various other components, in accordance with exemplary implementations;

FIG. 2 is a schematic illustrated battery cells in cell groups in a portion of the RESS of FIG. 1;

FIG. 3 is a schematic illustration of a representative battery cell in the vehicle of FIG. 1 that operates in accordance with aspects of the present disclosure;

FIG. 4 is a schematic illustration of a chemical reaction for forming a polymer dispersant for the cathode of the battery cell of FIG. 3; and

FIG. 5 is a flowchart illustrating a method for fabricating a cathode and for fabricating a battery in accordance with aspects of the present disclosure.

### DETAILED DESCRIPTION

The following detailed description is merely exemplary in nature and is not intended to limit the disclosure or the application and uses thereof. Furthermore, there is no intention to be bound by any theory presented in the preceding introduction or summary or the following detailed description.

Embodiments herein provide a polymeric dispersant for water-based cathode slurries used in fabrication of cathodes. Embodiments herein include the synthesis and use of a class of polymeric dispersants in aqueous-based cathode slurries.

Often, cathode slurries are formed with polyvinylidene fluoride (PVDF) binder dissolved in N-methyl-2-pyrrolidone (NMP). PVDF is considered a “forever chemical” with strict regulation on its use. Further, the use of NMP may be undesirable and require additional engineering controls and solvent reclamation.

Embodiments herein avoid use of PVDF as a binder. Further, embodiments herein avoid use of NMP as a solvent.

Rather, embodiments herein provide for preparation and use of an aqueous cathode material slurry to form cathodes. The aqueous cathode material slurry and the resulting cathode are free of PVDF, or substantially free of PVDF, and are free of NMP, or substantially free of NMP.

As used herein, a slurry or cathode that is “substantially free” of delineated compounds, may be completely free of the delineated compounds, i.e., contain less than the detectable level of the delineated compounds. In certain embodiments, a slurry or cathode that is “substantially free” of delineated compounds, may contain less than 0.05 weight percent of the delineated compounds in relation to the total weight of the slurry or cathode.

In some embodiments, the cathode active material may be a sulfur/carbon composite used in conjunction with lithiated polyacrylic acid (LiPAA) binder. In some embodiments, the cathode active material may be lithium iron phosphate (LFP) used in conjunction with CMC/SBR binders (carboxymethyl cellulose/styrene-butadiene rubber binders). While such combinations are described, embodiments herein are not limited to such cathode active materials and binders.

In fact, it has been determined that the polymeric dispersant described herein is useable in a variety of aqueous cathode chemistries and with a variety of binder systems.

Water-based cathode slurries frequently have dispersion issues leading to poor quality coating and electrochemical performance. Embodiments herein improve dispersion in the cathode active material slurry and improve the quality of cathode active material coating formed from the slurry. Further, embodiments herein provide a water-based cathode active material slurry with high loading.

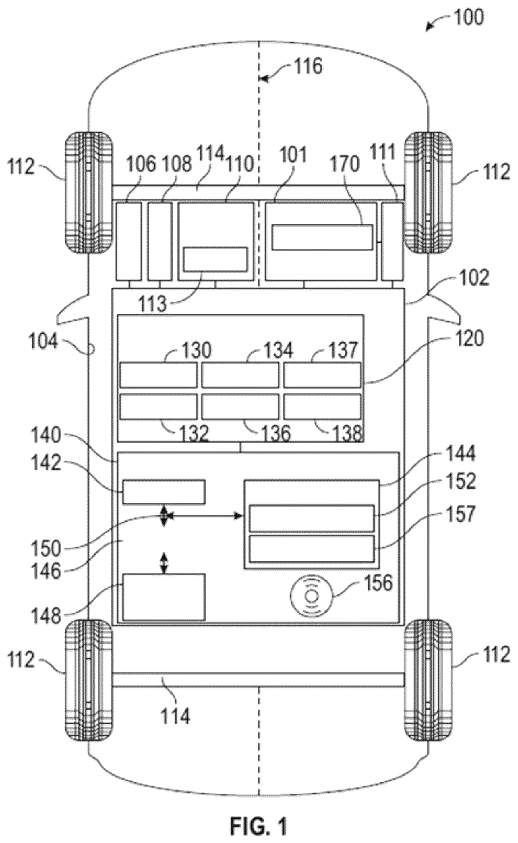

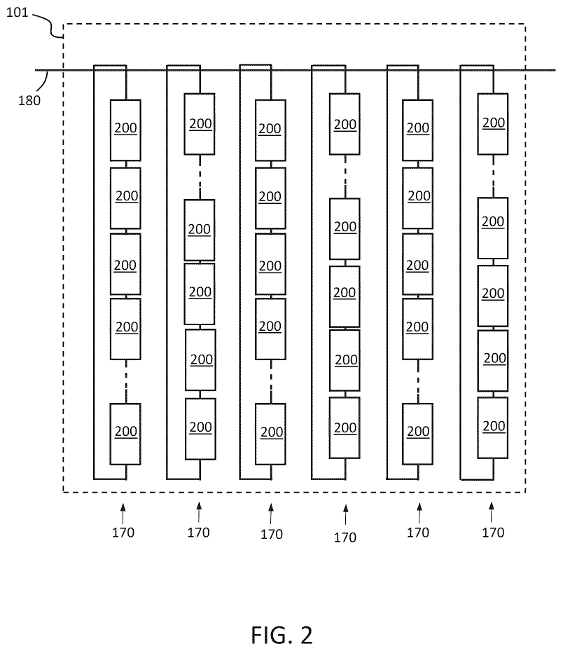

FIG. 1 illustrates a vehicle 100, according to an exemplary implementation. As described in greater detail further below, the vehicle 100 includes, among other components, a rechargeable energy storage system (“RESS”) 101 and a control system 102. In various implementations, the RESS 101 includes a plurality of cell groups 170, for example as depicted in FIG. 2 and described in greater detail further below in connection therewith. Also in various implementations, the control system 102 controls the RESS 101.

As depicted in FIG. 1, the RESS 101 and control system 102 are depicted as part of the vehicle 100 in accordance with exemplary implementations. In various implementations, the vehicle 100 comprises an automobile, such as any one of a number of different types of automobiles, such as, for example, a sedan, a wagon, a truck, sport utility vehicle (SUV), or the like. In certain implementations, the vehicle 100 may also comprise a motorcycle or other vehicle, such as aircraft, spacecraft, watercraft, and so on, and/or one or more other types of mobile platforms (e.g., a robot and/or another mobile platform). In yet other implementations, the RESS 101 and control system 102 may instead be part of and/or coupled to any number of other types of platforms and/or other systems, moving or non-moving, such as a building, infrastructure, secondary use, home power, non-automotive, and/or other platforms and/or other systems.

In the depicted implementation, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one implementation, the vehicle 100 includes four wheels 112, although this may vary in other implementations (for example for trucks, motorcycles, and certain other vehicles).

A drive system 110 is mounted on the chassis 116, and drives the wheels 112, for example via axles 114. In certain implementations, the drive system 110 comprises a propulsion system having an electric motor 113. In various implementations, the drive system 110, including the motor 113, receives high voltage from the RESS 101.

In various implementations, in addition to providing the high voltage to the motor 113, the RESS 101 also provides low voltage to one or more low voltage systems 111 of the vehicle 100. In various implementations, the low voltage systems 111 may include, by way of example, one or more climate control systems, radio systems, seat warming systems, and so on.

As depicted in FIG. 1, the vehicle also includes a braking system 106 and a steering system 108 in various implementations. In exemplary implementations, the braking system 106 controls braking of the vehicle 100 using braking components that are controlled via inputs provided by a driver (e.g., via a brake pedal) and/or automatically via a control system (such as the control system 102 and/or one or more other control systems). Also in exemplary implementations, the steering system 108 controls steering of the vehicle 100 via steering components that are controlled via inputs provided by a driver (e.g., via a steering wheel), and/or automatically via a control system (such as the control system 102 and/or one or more other control systems).

In the implementation depicted in FIG. 1, the control system 102 is coupled to the RESS 101, receives inputs therefrom, and controls functionality thereof. In addition, in certain implementations, the control system 102 is coupled to one or more of the braking system 106, steering system 108, drive system 110, and/or low voltage systems 111, and may also receive inputs from and/or control these additional systems in certain implementations.

Also as depicted in FIG. 1, in various implementations, the control system 102 includes a sensor array or arrangement 120 and a control module 140 (or controller), as described in greater detail below.

In various implementations, the sensor array 120 includes various sensors that obtain sensor data of the vehicle 100 for use in controlling, among other functionality, the RESS 101. In the depicted implementation, the sensor array 120 includes one or more voltage sensors 130, current sensors 132, temperature sensors 134, pressure sensors 136, gas sensors 137, and additional sensors 138.

In various implementations, the control module 140 is coupled to the sensor array 120 and receives sensor data therefrom. In various implementations, the control module 140 is further coupled to the RESS 101. In addition, in certain implementations, the control module 140 may also be coupled to one or more other systems of the vehicle 100, such as the braking system 106, steering system 108, drive system 110, and/or low voltage systems, for example for receiving input thereof and/or for controlling thereof.

As depicted in FIG. 1, in various implementations, the control module 140 comprises a computer system, and includes a processor 142, a memory 144, an interface 146, a storage device 148, and a computer bus 150.

The processor 142 performs the computation and control functions of the control module 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the control module 140 and the computer system of the control module 140, generally in executing the processes described herein.

The memory 144 can be any type of suitable memory, including various types of non-transitory computer readable storage medium. In certain examples, the memory 144 is located on and/or co-located on the same computer chip as the processor 142. In the depicted implementation, the memory 144 stores the above-referenced program 152 along with stored values 157 (e.g., look-up tables, thresholds, and/or other values with respect to control of the RESS 101).

The interface 146 allows communication to the computer system of the control module 140, for example from a system driver and/or another computer system, and can be implemented using any suitable method and apparatus. In one implementation, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

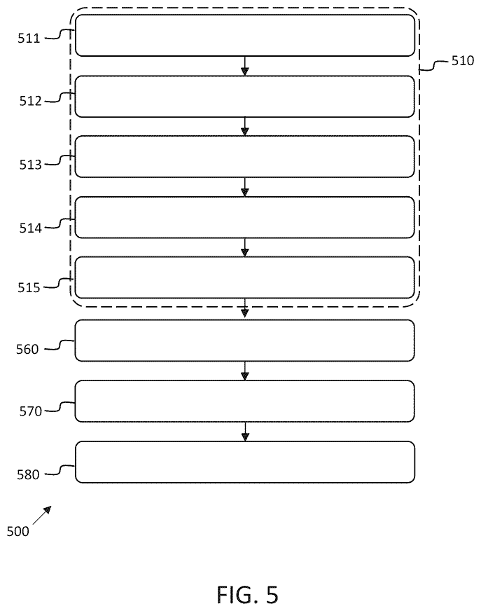

The storage device 148 can be any suitable type of storage apparatus, including various different types of direct access storage and/or other memory devices. In one exemplary implementation, the storage device 148 comprises a program product from which memory 144 can receive a program 152 that executes one or more implementations of one or more processes of the present disclosure, such as the steps of the method 500 of FIG. 5 and described further below in connection therewith. In another exemplary implementation, the program product may be directly stored in and/or otherwise accessed by the memory 144 and/or a disk (e.g., disk 156), such as that referenced below.

The bus 150 serves to transmit programs, data, status and other information or signals between the various components of the computer system of the control module 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary implementation is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

FIG. 2 is a functional diagram of a portion of the RESS 101 of FIG. 1, such as a battery module 101. As shown, the battery module includes a plurality of cell groups 170, in accordance with exemplary implementations.

As depicted in FIG. 2, in various implementations, the battery module 101 includes a number of cell groups 170. In certain embodiments, the cell groups 170 are connected in series via bus bar 180. The cells group may be configured electrically in series as shown and/or in parallel. It will be appreciated that the number and configuration of cell groups 170 may vary in different implementations, and the subject matter described herein is not limited to any particular number, type or configuration of cell groups 170. The bus bar 180 may be connected to the drive system 110.

In certain embodiments, each cell group 170 may include one or more battery cells 200 or other energy storage elements. As shown the battery cells 200 may be arranged in a stack, such that the cell groups 170 are referred to as cell stacks 170. The battery cells 200 may be configured electrically in series or in parallel to provide a desired DC voltage level and/or DC output current. While each cell group 170 is illustrated as including five battery cells 200, the number of battery cells 200 per cell group 170 may be any desired suitable number.

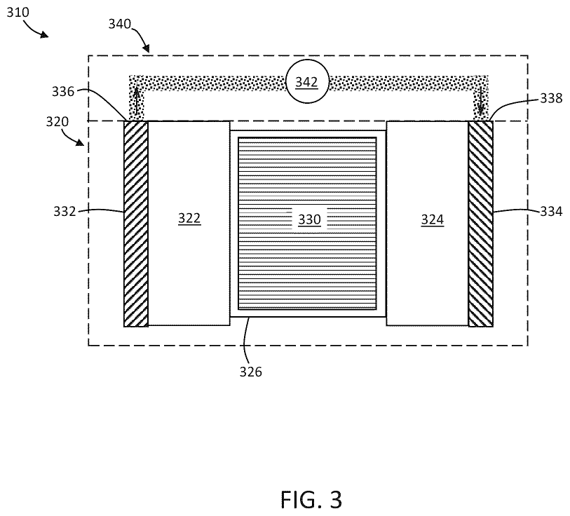

Presented in FIG. 3 is an exemplary electrochemical device in the form of a rechargeable battery 310, that powers a desired electrical load, such as vehicle 10 of FIG. 1, and offers fast charging capabilities, such as DCFC. Battery 310 includes a pair of electrically conductive electrodes, namely a first (negative or anode) working electrode 322 and a second (positive or cathode) working electrode 324, packaged inside a protective outer housing 320. In at least some configurations, the battery housing 320 may be an envelope-like pouch that is formed of aluminum foil or other suitable sheet material. Both sides of a metallic pouch may be coated with a polymeric finish to insulate the metal from the internal cell elements and from adjacent cells, if any. Alternatively, the battery housing (or “cell casing”) 320 may take on a cylindrical metal can configuration, i.e., for cylindrical battery cell configurations, or a polyhedral metal box configuration, i.e., for prismatic battery cell configurations. Reference to either working electrode 322, 324 as an “anode” or “cathode” or, for that matter, as “positive” or “negative” does not limit the electrodes 322, 324 to a particular polarity as the system polarity may change depending on whether the battery 310 is being operated in a charge mode or a discharge mode. Although FIG. 3 illustrates a single battery cell unit, such as a battery cell 200 of FIG. 2, inserted within the battery housing 320, it should be appreciated that the housing 320 may stow therein a stack of multiple cell units (e.g., five to five thousand cells or more), such as stack 170 of FIG. 2.

With continuing reference to FIG. 3, anode electrode 322 may be fabricated with an active anode electrode material that is capable of incorporating ions during a battery charging operation and releasing ions during a battery discharging operation. In at least some implementations, the anode electrode 322 is manufactured, in whole or in part, from a lithium metal, such as lithium-aluminum (LiAl) alloy materials with an Li/Al atomic ratio in a range from 0 at. %≤Li/Al<70 at. %, and/or aluminum alloys with Al atomic ratio>50 at. % (e.g., lithium metal is smelt). Additional examples of suitable active anode electrode materials include carbonaceous materials (e.g., graphite, hard carbon, soft carbon, etc.), silicon, silicon-carbon blended materials (silicon-graphite composite), Li₄Ti₅O₁₂, transition-metals (alloy types, e.g., Sn), metal oxide/sulfides (e.g., SnO₂, FeS and the like), etc.

Disposed inside the battery housing 320 between the two electrodes 322, 324 is a porous separator 326, which may be in the nature of a microporous or nanoporous polymeric separator. The porous separator 326 may include a non-aqueous fluid electrolyte composition and/or solid electrolyte composition, collectively designated 330, which may also be present in the negative electrode 322 and the positive electrode 324. A negative electrode current collector 332 may be positioned on or near the negative electrode 322, and a positive electrode current collector 334 may be positioned on or near the positive electrode 324. The negative electrode current collector 332 and positive electrode current collector 334 respectively collect and move free electrons to and from an external circuit 340. An interruptible external circuit 340 with a load 342 connects to the negative electrode 322, through its respective current collector 332 and electrode tab 336, and to the positive electrode 324, through its respective current collector 334 and electrode tab 338. Current collectors 332 and 334 may be formed from aluminum, copper or another suitable material. Separator 326 may be a sheet-like structure that is composed of a porous polyolefin membrane, e.g., with a porosity of about 35% to 65% and a thickness of approximately 25 to 30 microns. Electrically non-conductive ceramic particles (e.g., silica) may be coated onto the porous membrane surfaces of the separators 326.

The porous separator 326 may operate as both an electrical insulator and a mechanical support structure by being sandwiched between the two electrodes 322, 324 to prevent the electrodes from physically contacting each other and, thus, the occurrence of a short circuit. In addition to providing a physical barrier between the electrodes 322, 324, the porous separator 326 may provide a minimal resistance path for internal passage of ions (and related anions) during cycling of the ions to facilitate functioning of the battery 310. For some optional configurations, the porous separator 326 may be a microporous polymeric separator including a polyolefin. The polyolefin may be a homopolymer, which is derived from a single monomer constituent, or a heteropolymer, which is derived from more than one monomer constituent, and may be either linear or branched. In a solid-state battery, the role of the separator may be partially/fully provided by a solid electrolyte layer.

Operating as a rechargeable energy storage system (RESS), battery 310 generates electric current that is transmitted to one or more loads 342 operatively connected to the external circuit 340. While the load 342 may be any number of electrically powered devices, a few non-limiting examples of power-consuming load devices include an electric motor for a hybrid or full-electric vehicle, a laptop or tablet computer, a cellular smartphone, cordless power tools and appliances, portable power stations, etc. The battery 310 may include a variety of other components that, while not depicted herein for simplicity and brevity, are nonetheless readily available. For instance, the battery 310 may include one or more gaskets, terminal caps, tabs, battery terminals, and other commercially available components or materials that may be situated on or in the battery 310. Moreover, the size and shape and operating characteristics of the battery 310 may vary depending on the particular application for which it is designed.

### Positive Electroactive Material/Active Cathode Material

Cathode electrode 324 may be fabricated with a positive electroactive material, i.e., an active cathode electrode material that is capable of supplying ions during a battery charging operation and incorporating ions during a battery discharging operation. The cathode electrode 324 material may include, for instance, lithium transition metal oxide, phosphate, or silicate, such as LiMO₂ (M=Co, Ni, Mn, or combinations thereof); LiM₂O₄ (M=Mn, Ti, or combinations thereof), LiMPO₄ (M=Fe, Mn, Co, or combinations thereof), and LiMₓM′₂₋ₓO₄ (M, M′=Mn or Ni). Additional examples of suitable active cathode electrode materials include lithium nickel cobalt manganese oxide (NCM), lithium nickel cobalt aluminum oxide (NCA), lithium nickel cobalt manganese aluminum oxide (NCMA), and other lithium transition-metal oxides. The active cathode electrode material may also be or include sulfur/carbon composite material. For example, the active cathode electrode material may include sulfur located in porous carbon shells, which may be optionally coated with a polymer including nitrogen atoms. Other composite material structures may be suitable. In certain embodiments, the active cathode electrode material is selected from a sulfur/carbon composite material, lithium iron phosphate (LFP), lithium ion manganese oxide (LMO), lithium manganese (LMN), nickel cobalt manganese aluminum (NCMA), and/or a combination thereof.

### Electrically Conductive Material

In embodiments herein, the second (positive or cathode) working electrode 324 also includes, in addition to the active cathode electrode material, an additional electrically conductive material. The electrically conductive material may be selected from carbon-based materials, powdered nickel or other metal particles, or a conductive polymer. Carbon-based materials may include, for example, particles of graphite, acetylene black (such as DENKA™ black), carbon black (such as KETJEN™ black and/or Super C45 or C65), carbon fibers and nanotubes such as single-wall carbon nanotubes, graphene, graphene nanoplatelets, or other suitable conductive material. Examples of a conductive polymer include polyaniline, polythiophene, polyacetylene, polypyrrole, and the like.

### Binder

In embodiments herein, the second (positive or cathode) working electrode 324 also includes a binder material. In certain embodiments, the binder material is selected from styrene-butadiene rubber, acrylated styrene-butadiene rubber, acrylonitrile copolymer, acrylonitrile-butadiene rubber, nitrile butadiene rubber, acrylonitrile-styrene-butadiene copolymer, acryl rubber, butyl rubber, fluorine rubber, polytetrafluoroethylene, polyethylene, polypropylene, ethylene/propylene copolymers, polybutadiene, polyethylene oxide, chlorosulfonated polyethylene, polyvinylpyrrolidone, polyvinylpyridine, polyvinyl alcohol, polyvinyl acetate, polyepichlorohydrin, polyphosphazene, polyacrylonitrile, polystyrene, latex, acrylic resins, phenolic resins, epoxy resins, carboxymethyl cellulose, hydroxypropyl cellulose, cellulose acetate, cellulose acetate butyrate, cellulose acetate propionate, cyanoethylcellulose, cyanoethylsucrose, polyester, polyamide, polyether, polyimide, polycarboxylate, polycarboxylic acid, polyacrylic acid, polyacrylate, polymethacrylic acid, polymethacrylate, polyacrylamide, polyurethane, fluorinated polymer, chlorinated polymer, polyvinylidene fluoride, poly(vinylidene fluoride)-hexafluoropropene, and combinations thereof. For example, the binder material may be polyacrylic acid (PAA), polyvinyl pyrrolidone (PVP), polyvinyl alcohol (PVA), carboxymethyl cellulose (CMC) and styrene-butadiene rubber (SBR), carbohydrates, latex, and/or a combination thereof.

### Amphiphilic Disperant

The second (positive or cathode) working electrode 324 also includes an amphiphilic dispersant. As described below, electrode 324 is formed from a slurry. In embodiments herein, the slurry is aqueous. In order to form a high quality coating from the slurry the binder must be dispersed throughout the aqueous slurry. Therefore, the dispersant is provided in the slurry.

In certain embodiments herein, the dispersant has an alkyl-attached functional group and an ionic-based functional group.

In certain embodiments, the dispersant is formed by performing a post-secondary modification of Maleic-anhydride-containing polymers using alkyls having a nucleophilic functional group. For example, the polymer may be reacted with a base and excess alcohol or amine, and then neutralized to provide the product with a lithium cation (Li+). Thus, the compound used for neutralizing may donate a lithium cation. Lithium hydroxide may be the neutralizing compound as it readily donates its lithium cation during neutralization.

In certain embodiments, the dispersant is formed by nucleophilic substitution onto Maleic-anhydride-containing polymers. During nucleophilic substitution into maleic anhydride containing polymers, a nucleophile (a molecule with a lone pair of electrons) attacks the electrophilic anhydride ring within the polymer containing maleic anhydride units, causing the ring to open and form a new chemical bond with the nucleophile, essentially substituting a new functional group onto the polymer chain.

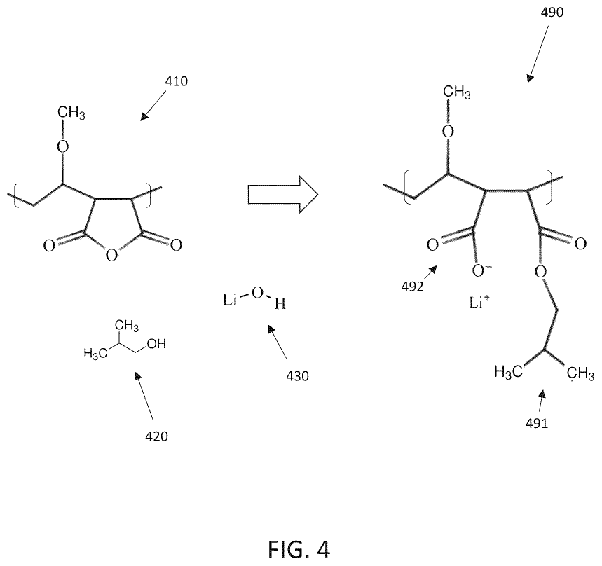

FIG. 4 illustrates an exemplary reaction in which the Maleic-anhydride-containing polymer 410 is poly(methyl vinyl ether-alt-maleic anhydride). The poly(methyl vinyl ether-alt-maleic anhydride) 410 is reacted with excess isobutanol 420 and then neutralized with lithium hydroxide 430 to form the dispersant 490. As shown, the dispersant 490 has an alkyl-attached functional group 491 and an ionic-based functional group 492.

While FIG. 4 illustrates a post-secondary modification of Maleic-anhydride-containing polymers using alkyls having a nucleophilic functional group, other methods may be used to form the dispersant 490. For example, a polymerization process may be performed to directly form the dispersant 490 without a post-polymerization modification step.

### Cathode Composition

In certain embodiments, the cathode electrode 324 includes from 80 to 99.5 weight percent of the active cathode electrode material, including all values and ranges therein. For example, cathode electrode 324 may include at least 80, at least 85, at least 90, at least 95, at least 96, at least 97, at least 98, or at least 99 weight percent of active cathode electrode material based on a total weight of the cathode electrode 324. Further, cathode electrode 324 may include at most 85, at most 90, at most 95, at most 96, at most 97, at most 98, at most 99, or at most 99.5 weight percent of active cathode electrode material based on a total weight of the cathode electrode 324.

In certain embodiments, the cathode electrode 324 includes from 0.1 to 10 weight percent of the additional electrically conductive material (if present), based on a total weight of the cathode electrode 324, including all values and ranges therein.

In certain embodiments, the cathode electrode 324 includes from 0.1 to 10 weight percent of binder based on a total weight of the cathode electrode 324, including all values and ranges therein.

In certain embodiments, the cathode electrode 324 includes from 0.1 to 5 weight percent of dispersant based on a total weight of the cathode electrode 324, including all values and ranges therein.

FIG. 5 is a flow chart illustrating a method 500 for making a battery, like the battery described above. As shown, method 500 may include forming a cathode at operation 510.

Operation 510 may include preparing a cathode slurry at operation 511. Operation 511 may include concurrently or consecutively adding positive electroactive material, one or more binders, optionally, one or more electrically conductive materials, and the polymer dispersant to water to form a combination.

Operation 510 may include milling the combination with a mixer at operation 512. The mixer may be a planetary, high-speed, acoustic, static mixer, extruder and dissolver. Milling may be performed for a suitable time period and at a suitable speed, and the combination may be maintained at about ambient or room temperature (e.g., greater than or equal to about 15° C. to less than or equal to about 40° C.) during the milling process. In certain embodiments, the slurry may be mixed at a rate of from 500 to 3000 rpm for a duration of from two to ten minutes. After mixing, the slurry is a homogeneous mixture, i.e., the slurry has a substantially homogenous consistency. In other words, each constituent is dispersed evenly throughout the slurry.

After the slurry is prepared in this manner, the solids portion of the slurry may include from 80 to 99.5 weight percent of the active cathode electrode material, including all values and ranges therein; from 0.1 to 10 weight percent of the additional electrically conductive material (if present), including all values and ranges therein; from 0.1 to 10 weight percent of binder, including all values and ranges therein; and from 0.1 to 5 weight percent of dispersant, including all values and ranges therein, all based on a total solids weight of the slurry.

After preparing the cathode slurry, operation 510 may further include, at operation 513, contacting the positive electrode or cathode material slurry with one or more surfaces of a positive electrode current collector (e.g., aluminum current collector). The contacting may include coating the one or more surfaces of the positive electrode current collector using, for example, a doctor blade or an automatic coater, by way of non-limiting example.

As shown, operation 510 may further include drying the as-applied slurry to form an electroactive material layer on or adjacent to the one or more surfaces of the current collector at operation 514. In certain variations, drying may include heating the current collector and electroactive material layer to about 70° C. While drying, the temperature may be maintained at no higher than 200° C.

Operation 510 may also include, at operation 515, calendaring the electroactive material layer at room temperature to form an electroactive material layer having a porosity greater than or equal to about 25 vol. % to less than or equal to about 50 vol. %, and in certain aspects, greater than or equal to 25 vol. % to less than or equal to 50 vol. %.

After calendaring the layer of slurry, processing of the layer is complete and the cathode electrode 324 is formed. Thus, method 500 may be considered to include at 510, forming the cathode from the slurry, which incorporates forming the slurry, applying the layer, drying the layer, and calendaring the layer.

In method 500, the cathode electrodes formed by the electroactive material layer may be prepared having target areal capacities of at least about 4.0 mAh/cm² (and in certain aspects, at least 4.5 mAh/cm² or at least 5.0 mAh/cm²).

After forming the cathode electrode 324, method 500 continues at operation 560 with assembling the battery 310 and cells thereof. For example, cathode electrode 324 and collector 334 may be positioned in battery housing 320 and spaced apart from anode electrode 322 and current collector 332 by porous separator 326 and in contact with electrolyte composition 330.

Thereafter, method 500 may include, at operation 570, performing a cycle of charge and discharge processes. Thereafter, method 500 may include, at operation 580, operating a device, such as vehicle 10, with power from the battery.

In a first example, a slurry was formed by adding to water, a carbon/sulfur composite cathode active material, a LiPAA binder, no additional electrically conductive material, and isobutyl-containing polymer dispersant. The slurry solids composition was 0.25 wt % polymer dispersant. A cathode was formed from the slurry as described above.

In comparison to typical carbon/sulfur cathodes formed using a PVDF binder and NMP solvent, the water-based cathode in the example displayed similar or improved discharge capacity retention. Further, the water-based cathode in the example exhibited a particle size reduction of from 70 micrometers to 40 micrometers.

In a second example, a slurry was formed by adding to water, an LFP cathode active material, CMC/SBR binder, no additional electrically conductive material, and isobutyl-containing polymer dispersant. The slurry solids composition was 97 wt. % LFP cathode active material, 0.5 wt % polymer dispersant, and 2.5 wt. % CMC/SBR binder. A cathode was formed from the slurry as described above.

In comparison to typical LFP cathodes formed using a PVDF binder and NMP solvent, the water-based cathode in the example displayed similar or improved discharge capacity retention and increased loading, such as to 4.5 mAh/cm², compared to 4.0 mAh/cm².

It will be appreciated that the batteries, vehicles, and methods may vary from those depicted in the Figures and described herein. It will similarly be appreciated that the operations of the methods may differ from that depicted in the Figures, and/or that various operations of the methods may occur concurrently and/or in a different order than that depicted and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for making a battery, the method comprising:
forming an amphiphilic polymer dispersant;
forming an aqueous cathode material slurry by concurrently or consecutively adding to water:
the amphiphilic polymer dispersant,
a positive electroactive material; and
a binder; and
forming a cathode from the aqueous cathode material slurry.

2. The method of claim 1, wherein forming the amphiphilic polymer dispersant comprises performing a post-secondary modification of Maleic-anhydride-containing polymers using alkyls having a nucleophilic functional group.

3. The method of claim 1, wherein forming the amphiphilic polymer dispersant comprises forming the amphiphilic polymer dispersant with an alkyl-attached functional group and an ionic-based functional group.

4. The method of claim 1, wherein the positive electroactive material comprises sulfur/carbon composite material, lithium iron phosphate (LFP), lithium ion manganese oxide (LMO), lithium manganese (LMN), nickel cobalt manganese aluminum (NCMA), and/or a combination thereof.

5. The method of claim 1, wherein the binder comprises polyacrylic acid (PAA), polyvinyl pyrrolidone (PVP), polyvinyl alcohol (PVA). carboxymethyl cellulose (CMC) and styrene-butadiene rubber (SBR), carbohydrates, latex, and/or a combination thereof.

6. The method of claim 1, wherein the aqueous cathode material slurry has a solids content of:
less than 5 wt % of the amphiphilic polymer dispersant; and
at least 95 wt % of the positive electroactive material; based on a total weight of solids of the aqueous cathode material slurry.

7. The method of claim 1, wherein the positive electroactive material comprises sulfur/carbon composite material and wherein the binder comprises lithiated polyacrylic acid (LiPAA).

8. The method of claim 1, wherein the positive electroactive material comprises lithium iron phosphate (LFP) material and wherein the binder comprises carboxymethyl cellulose (CMC) and styrene-butadiene rubber (SBR).

9. The method of claim 1, wherein the aqueous cathode material slurry is free of N-methyl-2-pyrrolidone (NMP).

10. The method of claim 1, wherein:
forming the amphiphilic polymer dispersant comprises performing a post-secondary modification of Maleic-anhydride-containing polymers using alkyls with a nucleophilic functional group;
the positive electroactive material comprises the positive electroactive material comprises sulfur/carbon composite material, lithium iron phosphate (LFP), lithium ion manganese oxide (LMO), lithium manganese (LMN), nickel cobalt manganese aluminum (NCMA), and/or combinations thereof;
the binder comprises polyacrylic acid (PAA), polyvinyl pyrrolidone (PVP), polyvinyl alcohol (PVA). carboxymethyl cellulose (CMC) and styrene-butadiene rubber (SBR), carbohydrates, latex, and/or a combination thereof;
the aqueous cathode material slurry has a solids content of less than 5 wt % of the amphiphilic polymer dispersant and at least 95 wt % of the positive electroactive material, based on a total solids weight of the aqueous cathode material slurry; and
the aqueous cathode material slurry is free of N-methyl-2-pyrrolidone (NMP).

11. A battery comprising:
an anode current collector;
an anode active material directly contacting the anode current collector;
a cathode current collector;
a cathode layer contacting the cathode current collector, wherein the cathode layer comprises a uniform mixture of an amphiphilic polymer dispersant, a positive electroactive material, and a binder;
a separator between the anode active material and the cathode layer; and
an electrolyte in contact with the anode active material and the cathode layer.

12. The battery of claim 11, wherein the amphiphilic polymer dispersant is formed by post-secondary modification of a Maleic-anhydride-containing polymer using an alkyl with a nucleophilic functional group.

13. The battery of claim 11, wherein the amphiphilic polymer dispersant has an alkyl-attached functional group and an ionic-based functional group.

14. The battery of claim 11, wherein the positive electroactive material comprises sulfur/carbon composite material, lithium iron phosphate (LFP), lithium ion manganese oxide (LMO), lithium manganese (LMN), nickel cobalt manganese aluminum (NCMA), and/or a combination thereof.

15. The battery of claim 14, wherein the binder comprises polyacrylic acid (PAA), polyvinyl pyrrolidone (PVP), polyvinyl alcohol (PVA). carboxymethyl cellulose (CMC) and styrene-butadiene rubber (SBR), carbohydrates, latex, and/or a combination thereof.

16. The battery of claim 15, wherein the cathode layer comprises a uniform mixture of the amphiphilic polymer dispersant, the positive electroactive material, the binder, and an additional electrically conductive material.

17. A vehicle comprising:
an electric motor configured to provide motive torque; and
a battery system operatively connected to the electric motor and operable to provide electrical power to the electric motor, wherein the battery system comprises a high voltage rechargeable battery including cell stacks, wherein each cell stack comprises battery cells, wherein each battery cell comprises:
a cathode electrode formed from an aqueous slurry of an amphiphilic polymer dispersant, a positive electroactive material, and a binder selected from polyacrylic acid (PAA), polyvinyl pyrrolidone (PVP), polyvinyl alcohol (PVA). carboxymethyl cellulose (CMC) and styrene-butadiene rubber (SBR), carbohydrates, latex, and/or a combination thereof;
an anode electrode;
a separator located between the anode electrode and the cathode electrode, and
an electrolyte in contact with the anode electrode and the cathode electrode.

18. The vehicle of claim 17, wherein the amphiphilic polymer dispersant is formed by post-secondary modification of a Maleic-anhydride-containing polymer using an alkyl with a nucleophilic functional group.

19. The vehicle of claim 17, wherein the amphiphilic polymer dispersant has an alkyl-attached functional group and an ionic-based functional group.

20. The vehicle of claim 17, wherein the positive electroactive material comprises sulfur/carbon composite material, lithium iron phosphate (LFP), lithium ion manganese oxide (LMO), lithium manganese (LMN), nickel cobalt manganese aluminum (NCMA), and/or a combination thereof.
